(19) United States
(12) Patent Application Publication
(10) Pub. No.: US 2009/0040593 A1
(43) Pub. Date: Feb. 12, 2009

(54) OPTICAL MODULATOR HAVING MULTIPLE RIBBON STRUCTURE

(75) Inventor: Seung-Do An, Suwon-si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: SAMSUNG ELECTRO-MECHANICS CO., LTD., Suwon (KR)

(21) Appl. No.: 12/182,986

(22) Filed: Jul. 30, 2008

(30) Foreign Application Priority Data
Aug. 6, 2007 (KR) 10-2007-0078586

(51) Int. Cl. G02F 1/01

(52) U.S. Cl. 359/292

(57) ABSTRACT

An optical modulator using a plurality of ribbons for rendering a pixel of an image is disclosed. An embodiment of the present invention provides an optical modulator having a multiple ribbon structure that can include a substrate and a first driving ribbon group and a second driving ribbon group, each of which includes at least one ribbon spaced from the substrate and driven upward or downward in accordance with a supplied voltage. A relative displacement between the first driving ribbon group and the second driving ribbon group can modulate an incident beam. By alternately driving the first driving ribbon group and the second driving ribbon group, the image quality of the optical modulator in accordance with an embodiment of the present invention can be robust against environmental factors, such as time, time, temperature and fatigue, and hysteresis.

### CROSS-REFERENCE TO RELATED APPLICATION

This application claims the benefit of Korean Patent Application No. 10-2007-0078586, filed with the Korean Intellectual Property Office on Aug. 6, 2007, the disclosure of which is incorporated herein by reference in its entirety.

### BACKGROUND OF THE INVENTION

1. Field of the Invention

The present invention is directed to an optical modulator used in a display device, more specifically to an optical modulator using a plurality of ribbons to render a pixel of an image.

2. Description of the Related Art

With the recent development of projection television sets, optical modulators and scanners are used as means for scanning beams on a screen. A scanning display device using such optical modulator and scanner is illustrated in FIG. 1.

A scanning display device 100 includes a light source 110, an optical modulator 120, a driving circuit 125, a scanner 130, and an image processing unit 150.

An illumination optical system 115 is placed between the light source 110 and the optical modulator 120 to change the direction of the light from the light source 110 and collects the light to the optical modulator 120.

The optical modulator 120 outputs a modulation beam, to which an incident beam from the light source 110 is modulated. In the optical modulator 120, a plurality of micro-mirrors are arranged in a row, and one or more micro-mirrors are responsible for one pixel and output a modulation beam corresponding to a linear image (i.e., a vertical scanning line or a horizontal scanning line).

A condensing optical system 131 delivers the modulation beam, outputted from the optical modulator 120, to the scanner 130. The condensing optical system 131 can include one or more lenses and adjust the magnification as necessary to deliver a magnified or reduced modulation beam according to the ratio between the size of the optical modulator 120 and the size of the scanner 130.

A projection optical system includes a projection lens (not shown) and allows the modulation beam from the optical modulator 120 to be projected on the scanner 130 or, by being placed between the scanner 130 and the screen 140, allows a beam from the scanner 130 to be projected on the screen 140.

The scanner 130 scans the modulation beam from the optical modulator 120 in a predetermined direction and displays a linear image successively to render a two-dimensional image on the screen 140.

The modulation beam from the optical modulator 120 can be a diffraction beam #0, diffraction beam #+n or diffraction beam #−n, whereas “n” is a natural number. Each diffraction beam is projected to the screen 140 by the scanner 130. Since the path of each diffraction beam is different, a slit is used to select a desired diffraction beam to be projected to the screen 140. It is also possible, by placing the slit in the front of the scanner 130, to allow only a desired diffraction beam to be incident on the scanner 130 from the modulation beam incident on the scanner 130.

The image processing unit 150 generates a light source control signal, an image control signal and a scanner control signal, corresponding to an inputted image signal, and controls the operations of the light source 110, driving circuit 125 and scanner 130. The driving circuit 125 changes the displacement of the micro-mirror of the optical modulator 120 in accordance with the image control signal and modulates an incident beam to a modulation beam.

The optical modulator applied here modulates a beam by controlling the on/off status of the beam or by using the reflection/diffraction. The method of using the reflection/diffraction can be further divided into an electrostatic type and a piezoelectric type. Although the piezoelectric type will be described hereinafter, it shall be evident that the description can be also applied to the electrostatic type.

FIGS. 2A and 2B illustrate a micro-mirror included in an open-hole structure of optical modulator.

The micro-mirror 200 includes a substrate 210, an insulation layer 220, a sacrificial layer 230, a ribbon structure 240 and a piezoelectric element 250.

The insulation layer 220 is stacked on the substrate 210, and the sacrificial layer 230 is placed to space the ribbon structure 240 from the insulation layer 220. The ribbon structure interferes with the incident beam and optically modulates the signal. There can be a plurality of open holes 240b in the center of the ribbon structure 240. Although the open hole 240b is illustrated here to be in a shape of a rectangle along the length of the micro-mirror 200, it is also possible that the open hole 240b is in the shape of a circle, ellipse, etc. It is also possible that there are a plurality of rectangular open holes arranged parallel along the width of the micro-mirror 200.

The piezoelectric element 250 controls the ribbon structure 240 to move up and down in accordance with the amount of contraction or expansion in the direction of up and down or left and right caused by a voltage difference between an upper electrode and a lower electrode. Here, a lower reflective layer 220a is formed corresponding to the open hole 240b, which is formed on the ribbon structure 240.

For example, in case that the wavelength of a beam of light is λ, a first voltage is supplied to the piezoelectric element 250 such that the gap between an upper reflective layer 240a, formed on the ribbon structure 240, and the lower reflective layer 220a, formed on the insulation layer 220, becomes (2l)λ/4, whereas l is a natural number. For the diffraction beam #0, the overall path length difference between the light reflected by the upper reflective layer 240a and the light reflected by the lower reflective layer 220a is equal to lλ, so that constructive interference occurs and the modulation beam renders its maximum luminance. The diffraction beam #+1 and the diffraction beam #−1, however, have the minimum luminance due to destructive interference.

A second voltage is supplied to the piezoelectric elements 250 such that the gap between the upper reflective layer 240a, formed on the ribbon structure 240, and the lower reflective layer 220a, formed on the insulation layer 220, becomes (2l+1)λ/4, whereas l is a natural number. For the diffraction beam #0, the overall path length difference between the light reflected by the upper reflective layer 240a and the light reflected by the insulation layer 220a is equal to (2l+1)λ/2, so that destructive interference occurs, and the modulation beam renders its minimum luminance. The diffraction beam #+1 and the diffraction beam #−1, however, have the maximum luminance due to constructive interference.

As a result of such interference, the micro-mirror can load a signal for one pixel on a beam of light by adjusting the quantity of the reflected or diffracted light. Although the foregoing describes the cases of the gap between the ribbon structure 240 and the insulation layer 220 being (2l)λ/4 or (2l+1)λ/4, the gap between the ribbon structure 240 and the insulation layer 220 can be changed to adjust the luminance of a beam interfered by the diffraction and/or reflection of an incident beam. Hereinafter, the diffraction beam #0, diffraction beam #+n and diffraction beam #−n will be collectively referred to as a modulation beam.

FIG. 2B is a plan view of an optical modulator including a plurality of micro-mirrors illustrated in FIG. 2A.

Referring to FIG. 2B, the optical modulator includes micro-mirrors 200-1, 200-2, . . . , 200-m in the quantity of m, each of which corresponds to pixel #1, pixel #2, . . . , pixel #m. The optical modulator is responsible for image information on a one-dimensional image of a vertical scanning line or a horizontal scanning line, whereas it is presumed that the vertical scanning line or horizontal scanning line consists of m pixels. Each of the micro-mirrors 200-1, 200-2, . . . , 200-m is responsible for one of the m pixels, constituting the vertical or horizontal scanning line. Thus, the beam reflected and/or diffracted by the micro-mirror is later projected as a two-dimensional image on the screen by an optical scanning device.

The open-hole type of optical modulator of FIGS. 2A and 2B, in which one micro-mirror is responsible for one pixel, is easier to manufacture and costs less to mass-produce than the multiple-ribbon type of optical modulator, in which a plurality of micro-mirrors are responsible for one pixel. However, the image quality of the open-hole type of optical modulator is sensitive to environmental factors, such as time, temperature and fatigue.

### SUMMARY OF THE INVENTION

The present invention provides an optical modulator having a multiple ribbon structure in which the image quality is not sensitive to environmental factors, such as time, temperature and fatigue, and/or hysteresis by driving a first driving ribbon group and a second driving ribbon group alternately.

The present invention also provides an optical modulator having a multiple ribbon structure that can correct the black level by allowing adjustment of displacement for all ribbons belonging to a first ribbon group and a second ribbon group.

An aspect of the present invention features an optical modulator having a multiple ribbon structure. The optical modulator in accordance with an embodiment of the present invention can include a substrate and a first driving ribbon group and a second driving ribbon group, each of which can include at least one ribbon spaced from the substrate and driven upward or downward in accordance with a supplied voltage. A relative displacement between the first driving ribbon group and the second driving ribbon group can modulate an incident beam.

The first driving ribbon group and the second driving ribbon group, which include every other ribbon, respectively, can be classified as standing ribbons and driving ribbons, respectively.

No voltage can be supplied to a driving ribbon group corresponding to the standing ribbons. Alternatively, a voltage can be supplied to a driving ribbon group corresponding to the standing ribbons, or a voltage supplied in a preceding image frame can be continuously supplied to a driving ribbon group corresponding to the standing ribbons.

A voltage can be supplied to a driving ribbon group corresponding to the driving ribbons such that a driving ribbon group corresponding to the standing ribbons can have a relative displacement corresponding to a luminance of a pixel to be rendered in the image frame.

Initial locations of ribbons can be corrected with reference to a ribbon, the bottom of which is the lowest among ribbons belonging to the first driving ribbon group and the second driving ribbon group.

Initial locations of ribbons can be corrected with reference to a ribbon, the bottom of which is the highest among ribbons belonging to the first driving ribbon group and the second driving ribbon group.

### BRIEF DESCRIPTION OF DRAWINGS

FIG. 1 shows the brief structure of a scanning display device using an optical modulator and a scanner.

FIGS. 2A to 2B show micro-mirrors included in an open-hole type of optical modulator.

FIG. 3 shows a three-dimensional perspective view of an optical modulator having a multiple ribbon structure in accordance with an embodiment of the present invention.

FIGS. 4A and 4B show how ribbons are driven in a conventional optical modulator having a multiple ribbon structure.

FIGS. 5A to 5C show how ribbons are driven in an optical modulator having a multiple ribbon structure in accordance with an embodiment of the present invention.

FIG. 6 shows discord in initial positions of ribbons caused by reasons such as process error in an optical modulator having a multiple ribbon structure.

FIG. 7 shows a result of black level correction in a conventional optical modulator having a multiple ribbon structure.

FIG. 8 shows a result of black level correction in an optical modulator having a multiple ribbon structure in accordance with an embodiment of the present invention.

### DETAILED DESCRIPTION OF CERTAIN INVENTIVE EMBODIMENTS

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the spirit and scope of the present invention. Throughout the description of the present invention, when describing a certain technology is determined to evade the point of the present invention, the pertinent detailed description will be omitted.

Terms such as “first” and “second” can be used in describing various elements, but the above elements shall not be restricted to the above terms. The above terms are used only to distinguish one element from the other.

The terms used in the description are intended to describe certain embodiments only, and shall by no means restrict the present invention. Unless clearly used otherwise, expressions in the singular number include a plural meaning. In the present description, an expression such as “comprising” or “consisting of” is intended to designate a characteristic, a number, a step, an operation, an element, a part or combinations thereof, and shall not be construed to preclude any presence or possibility of one or more other characteristics, numbers, steps, operations, elements, parts or combinations thereof.

Hereinafter, an embodiment of the present invention will be described in detail with reference to the accompanying drawings.

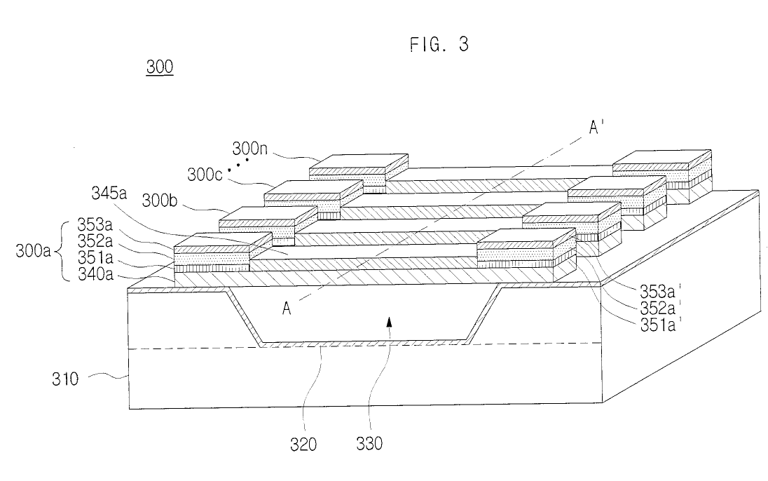

FIG. 3 is a three-dimensional perspective view of an optical modulator having a multiple ribbon structure in accordance with an embodiment of the present invention.

The optical modulator having a multiple ribbon structure 300 includes micro-mirrors (hereinafter referred to as “ribbon”) 300a, 300b, . . . , 300n in the quantity of n, whereas “n” is a natural number of 2 or greater.

Referring to a first ribbon 300a, an insulation layer 320 is stacked on a substrate 310. Both ends of the substrate 310 support the ribbon 300a, and the center of the substrate 310 has a cavity 330 such that the ribbon 300a can move up and down. The substrate can be made from at least one selected from the group consisting of Si, Al₂O₃, ZrO₂, Quartz and SiO₂.

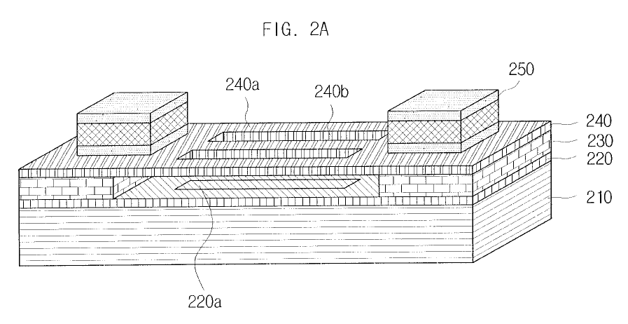

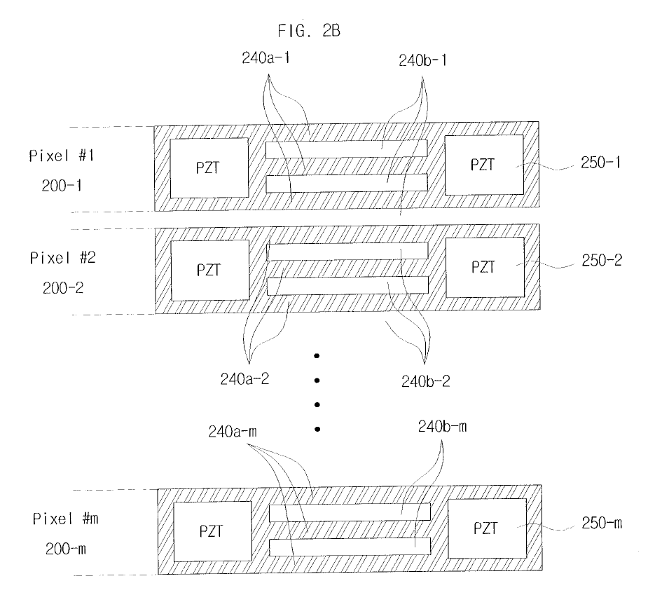

It is also possible, as illustrated in FIG. 2A, to further include a sacrificial layer below the ribbon 300a to provide space to allow the ribbon 300a to move up and down.

A lower support 340a is adhered to both ends outside the cavity, and the center of the lower support 340a can move up and down over the cavity. The left and right ends of the lower support 340a are stacked with a piezoelectric element. The piezoelectric element stacked on the left end includes a lower electrode layer 351a, which is for supplying piezoelectric voltage, a piezoelectric material layer 352a, which is stacked on the lower electrode layer 351a and contracts and/or expands to cause upward and downward movement when voltage is supplied to both ends, and an upper electrode layer 353a, which is stacked on the piezoelectric material layer 352a and is for supplying piezoelectric voltage. Similarly, the piezoelectric element stacked on the right end includes a lower electrode layer 351a′, a piezoelectric material layer 352a′ and an upper electrode layer 353a′.

On the upper part of the lower support 340a, at the center area of the ribbon 300a, a mirror layer 345a is stacked, reflecting or diffracting an incident beam. The mirror layer 345a is made from a metal (e.g. Al, Pt, Cr, Ag, etc.).

The optical modulator having a multiple ribbon structure renders image information for one pixel, using these multiple ribbons. In FIG. 3, the n ribbons 300a, 300b, . . . , 300n are used to render the intensity of one pixel.

In the below description, the optical modulator having a multiple ribbon structure along the AA′ line will be described. Although 12 ribbons rendering image information of one pixel will be described, it shall be understood that the present invention is not restricted to what is described herein. Likewise, although a piezoelectric type is described, it shall be evident that the same description can be applied to an electrostatic type.

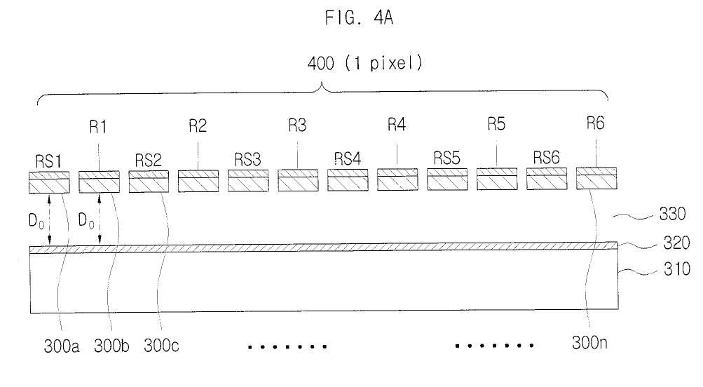

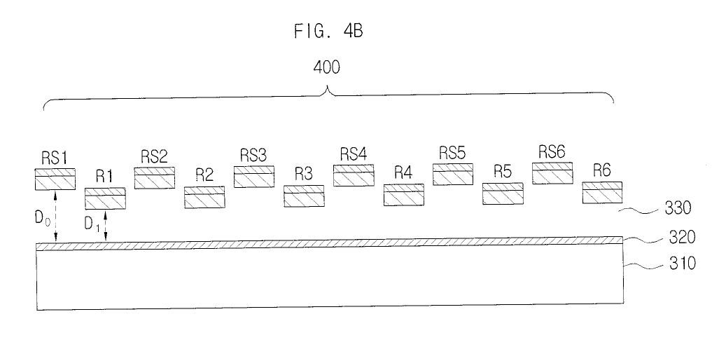

FIGS. 4A and 4B illustrate how ribbons are driven in a conventional optical modulator having a multiple ribbon structure. Twelve ribbons make up one group 400, which renders image information corresponding to one pixel.

Among the twelve ribbons, odd-numbered ribbons (i.e. RS1, RS2, RS3, RS4, RS5 and RS6) are standing ribbons, maintaining a fixed distance, D0, from the insulation layer 320 as no voltage or a predetermined voltage is supplied to the piezoelectric material of the ribbon.

Even-numbered ribbons (i.e. R1, R2, R3, R4, R5 and R6) are driving ribbons, which change the distance between the insulation layer 320 according to the voltage supplied to the piezoelectric element. For instance, the distance is changed from D0 in FIG. 4A to D1 in FIG. 4B.

In this kind of optical modulator having a multiple ribbon structure, the luminance of a modulation beam is controlled by using the displacement (i.e. 0 in FIG. 4A and D0-D1 in FIG. 4B) between the standing ribbons and driving ribbons.

Suppose that the wavelength of the beam is λ, for example. The gap between the standing ribbons and the driving ribbons is (2l)λ/4, whereas l is a natural number. For the diffraction beam #0, the overall path length difference between the light reflected by the standing ribbons and the light reflected by the driving ribbons is equal to lλ, so that constructive interference occurs and the modulation beam renders its maximum luminance. The diffraction beam #+1 and the diffraction beam #−1, however, have the minimum luminance due to destructive interference.

If the gap between the standing ribbons and the driving ribbons is (2l+1)λ/4, whereas l is a natural number, the overall path length difference for the diffraction beam #0 between the light reflected by the standing ribbons and the light reflected by the driving ribbons is equal to (2l+1)λ/2, so that destructive interference occurs, and the modulation beam renders its minimum luminance. The diffraction beam #+1 and the diffraction beam #−1, however, have the maximum luminance due to constructive interference.

As a result of such interference, the optical modulator having a multiple ribbon structure can load a signal for one pixel on a beam of light by adjusting the quantity of the diffracted light. Although the foregoing describes the cases of the gap between the standing ribbons and driving ribbons being (2l)λ/4 or (2l+1)λ/4, it shall be evident that the present invention can have a wide variety of embodiments in which the gap between the standing ribbons and driving ribbons can be changed to adjust the luminance of a beam interfered by the diffraction and/or reflection of an incident beam.

In the conventional optical modulator having a multiple ribbon structure, the standing ribbons are always fixed and only the driving ribbons move up and down. Thus, after driving for a while, the driving ribbons become to show hysteresis due to frequent up and down movements. Therefore, even though the same voltage was supplied, the range of movement of the driving ribbons changes, ultimately causing negative effects on the image quality.

Therefore, described hereinafter is an embodiment of the present invention in which the standing ribbons and driving ribbons alternately change the position in order to minimize the negative effect described above.

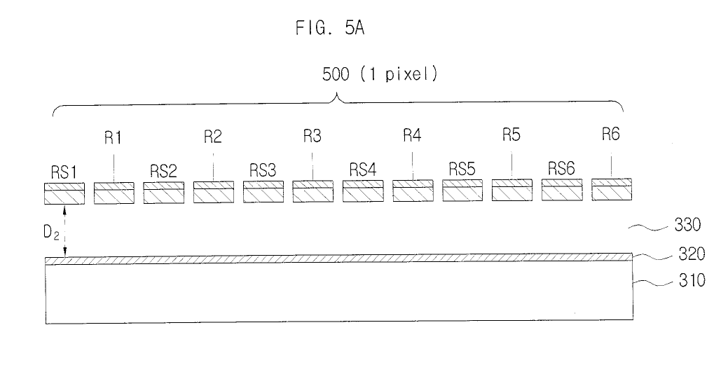

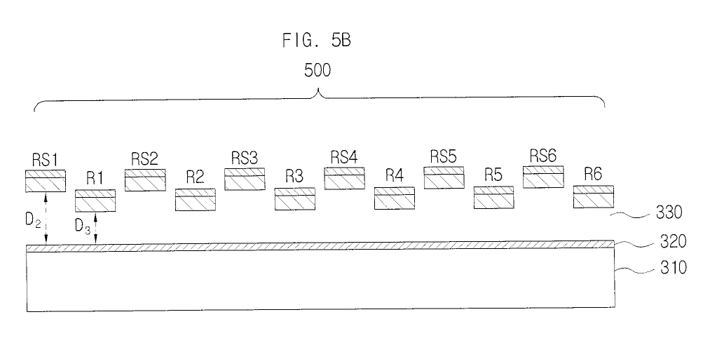

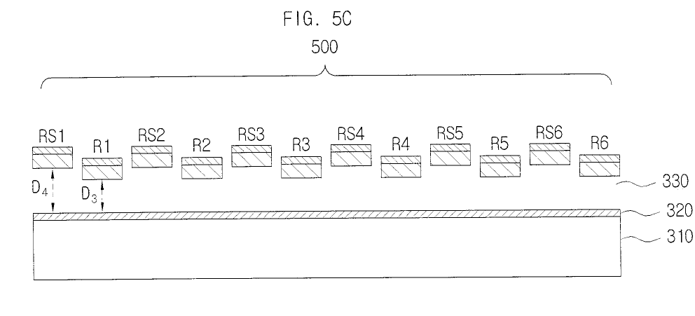

FIGS. 5A to 5C show how ribbons are driven in an optical modulator having a multiple ribbon structure in accordance with an embodiment of the present invention. Twelve ribbons make up a group 500, which renders image information corresponding to one pixel.

Unlike the conventional classification into standing ribbons and driving ribbons, the twelve ribbons are classified into a first driving ribbon group and a second driving ribbon group, which correspond to the conventional standing ribbons and the conventional driving ribbons, respectively.

In case no voltage is supplied to the piezoelectric element of the ribbons belonging to the first driving ribbon group (i.e. RS1 to RS6) and the second driving ribbon group (i.e. R1 to R6), it is presumed that the distance from the insulation layer 320 is D₂ (refer to FIG. 5A).

In case the twelve ribbons try to render image information of a pixel belonging to an Nth image frame, the ribbons belonging to the first driving ribbon group (RS1 to RS6) become standing ribbons, and the ribbons belonging to the second driving ribbon group (R1 to R6) become driving ribbons (refer to FIG. 5B). In other words, voltage is not supplied to the piezoelectric element of the ribbons belonging to the first driving ribbon group (RS1 to RS6), and a predetermined voltage is supplied to the piezoelectric element of the ribbons belonging to the second driving ribbon group (R1 to R6). In this case, the distance between the ribbons belonging to the first driving ribbon group and the insulation layer 320 is D₂, and the distance between the ribbons belonging to the second driving ribbon group and the insulation layer 320 is D₃. The luminance of the diffraction beam is determine by the displacement (D₂−D₃) between the ribbons belonging to the first driving ribbon group and the ribbons belonging to the second ribbon groups, and thus the predetermined voltage supplied to the piezoelectric element of the ribbons belong to the second driving ribbon group is determined with the consideration of D₂.

Then, in case the twelve ribbons try to render image information of a pixel belonging to an N+1st image frame, the ribbons belonging to the first driving ribbon group (RS1 to RS6) become driving ribbons, and the ribbons belonging to the second driving ribbon group (R1 to R6) become standing ribbons (refer to FIG. 5C). In other words, the same voltage supplied to the Nth image frame is continuously supplied to the piezoelectric element of the ribbons belonging to the second driving ribbon group (R1 to R6), and voltage calculated in accordance with the N+1^{st} image frame is supplied to the piezoelectric element of the ribbons belonging to the first driving ribbon group (RS1 to RS6). In this case, the distance between the ribbons belonging to the second driving ribbon group and the insulation layer 320 is maintained to be D₃, and the distance between the ribbons belonging to the first driving ribbon group and the insulation layer 320 becomes D₄. The luminance of the diffraction beam is determine by the displacement (D₄−D₃) between the ribbons belonging to the first driving ribbon group and the ribbons belonging to the second ribbon groups, and thus the predetermined voltage supplied to the piezoelectric element of the ribbons belong to the first driving ribbon group is determined with the consideration of D₃.

That is, the voltage supplied to the ribbons belonging to the first driving ribbon group (RS1 to RS6) corresponding to the driving ribbons for the N+1^{st} image frame is based on the location of the ribbons belonging to the second driving ribbon group (R1 to R6) corresponding to the driving ribbons in the Nth image frame, which is the previous frame, and thus allows the location of the ribbons belonging to the first driving ribbon group (R1 to R6) to render the corresponding luminance.

Although it is assumed in the above embodiment that the first driving ribbon group corresponds to the standing ribbons in the Nth image frame and the second driving ribbon group corresponds to the driving ribbons, it is evident that the first driving ribbon group can correspond to the driving ribbons and the second driving ribbon group can correspond to the standing ribbons.

Alternatively, in another embodiment of the present invention, as the first driving ribbon group corresponds to the standing ribbons in the Nth image frame, the gap from the insulation layer 320 can become D₂ by not supplying a voltage to the piezoelectric element of the ribbons belonging to the first driving ribbon group.

As the second driving ribbon group corresponds to the standing ribbons in the N+1^{st} image frame, the gap from the insulation layer 320 is made to be D₂, by not supplying any voltage to the piezoelectric element of the ribbons belonging to the second driving ribbon group rather than continuing to supply the voltage supplied to the previous image frame.

That is, it is possible, by not supplying any voltage to the piezoelectric element of the ribbons belonging to the driving ribbon group corresponding to the standing ribbons in each image frame, to maintain the gap from the insulation layer 320 at D₂, regardless of the location in the previous image frame. Since the location of the standing ribbons is always constant, the magnitude of voltage to be supplied to the piezoelectric element of the ribbons belonging to the driving ribbon group corresponding to the driving ribbons can be calculated by considering only the relative displacement between the standing ribbons and driving ribbons that determines the intensity of the modulation beam.

In another embodiment of the present invention, it is possible to supply a constant voltage to the driving ribbon group corresponding to the standing ribbons. While the gap of the standing ribbons is constant at D₂ as described above, the gap of the standing ribbons is in effect constant even when the constant voltage is supplied.

As described above, the ribbons are classified into the first driving ribbon group and the second driving ribbon group and are alternately driven in each image frame, every ribbon gets to have either the same or similar hysteresis, making it less sensitive to image deterioration caused by hysteresis.

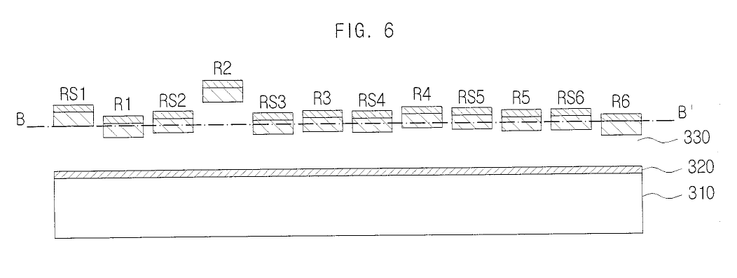

Hereinafter, FIGS. 6 to 8 will be referred to describe black level correction in an optical modulator having a multiple ribbon structure. Black level correction refers to having the diffraction beam #+1 or the diffraction beam #−1 render the darkest luminance, that is, black, by making the displacement of all ribbons identical in an optical modulator having a multiple ribbon structure.

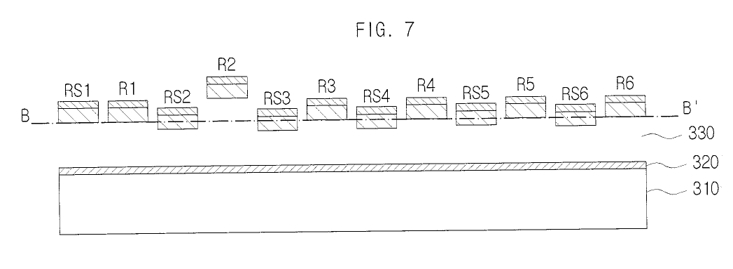

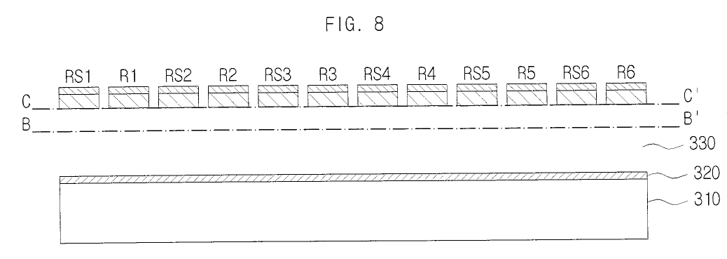

FIG. 6 shows discord in initial positions of ribbons caused by reasons such as process error in an optical modulator having a multiple ribbon structure. FIG. 7 shows a result of black level correction in a conventional optical modulator having a multiple ribbon structure, and FIG. 8 shows a result of black level correction in an optical modulator having a multiple ribbon structure in accordance with an embodiment of the present invention.

Referring to FIG. 6, it is preferable that the ribbons in an optical modulator are spaced at a fixed gap from the insulation layer 320. However, due to various reasons, the actual process can have an error, and thus it is possible that the initial positions of the ribbons are not identical.

For instance, referring to the BB′ line, which is extended from the lower side of an RS1 ribbon, the bottom of an R2 ribbon may be higher than the BB′ line, and the bottoms of the rest of the ribbons may be lower than the BB′ line.

In the conventional optical modulator having a multiple ribbon structure, the discord in the initial location is corrected by supplying a voltage for each ribbon. However, the initial location may be driven to one direction only, that is, upward or downward, in the conventional optical modulator.

FIG. 7 will describe driving the ribbons upward only. In the conventional optical modulator having a multiple ribbon structure, the standing ribbons of RS1, RS2, RS3, RS4, RS5 and RS6 basically can not be corrected.

It is possible, however, to correct the initial location of R1, R3, R4, R5 and R6 ribbons whose bottoms are lower than the BB′ line by supplying a voltage corresponding to the displacement between the initial location and the BB′ line. Supplying a voltage to R2 ribbon, the bottom of which is higher than the BB′ line, will drive the ribbon upward, making it impossible to correct the discord in initial location.

Therefore, as shown in FIG. 7, not all ribbons have the same initial location, resulting in partial correction of black level.

In the meantime, an embodiment of the present invention makes it possible to drive all ribbons for black level correction. Referring to FIG. 8, which presumes that the ribbons are driven upward only, correction of initial location of all ribbons becomes possible by supplying a voltage corresponding to the displacement between the initial location and the CC′ line, which is extended from the bottom of R2 ribbon, the bottom of which is the highest among all ribbons, such that the bottoms of all ribbons are aligned along the CC′ line.

In other words, the correction of discord in initial location and thus black level is possible by having all ribbons are placed at the same distance from the insulation layer 320.

Although the upward driving has been described in the above embodiment, the black level correction is also possible by correcting the bottoms of the ribbons in accordance with a ribbon, the bottom of which is the lowest.

Moreover, although the bottom of a ribbon has been used as a reference height, it is also possible to us the top or center of a ribbon as the reference height.

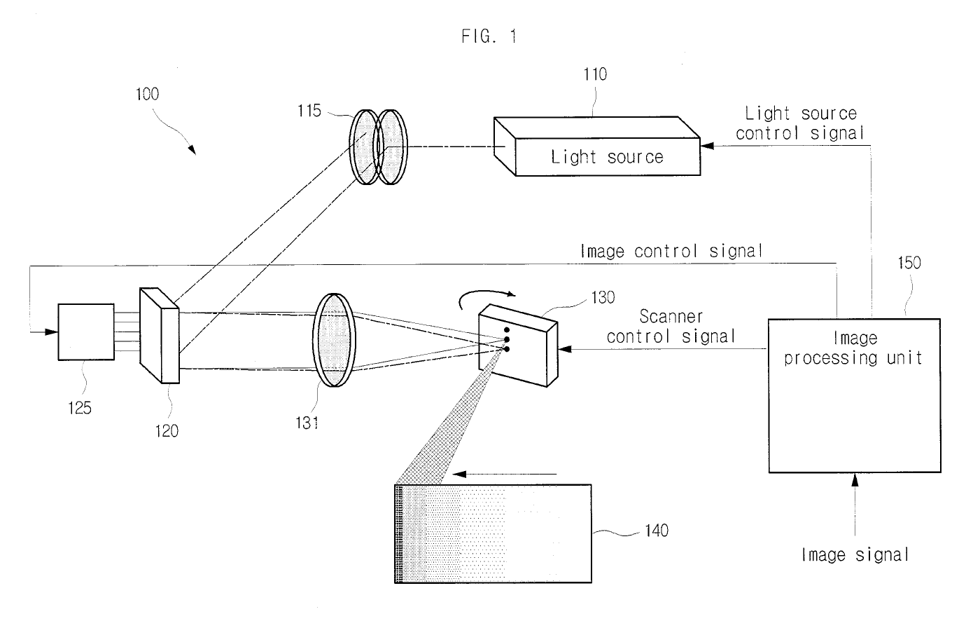

Furthermore, the black level correction described above can be also carried out in the image processing unit, illustrated in FIG. 1, or by incorporating a separate processing unit.

Although certain embodiments of the present invention have been described, it shall be evident to anyone of ordinary skill in the art that there can be a large number of permutations or modifications are possible without departing from the technical ideas of the present invention, which shall be only defined by the appended claims.

What is claimed is:

1. An optical modulator having a multiple ribbon structure, the optical modulator comprising:
a substrate; and
a first driving ribbon group and a second driving ribbon group, each of which comprising at least one ribbon spaced from the substrate and driven upward or downward in accordance with a supplied voltage,
wherein a relative displacement between the first driving ribbon group and the second driving ribbon group modulates an incident beam.

2. The optical modulator of claim 1, wherein the first driving ribbon group and the second driving ribbon group, which include every other ribbon, respectively, are classified as standing ribbons and driving ribbons, respectively.

3. The optical modulator of claim 2, wherein no voltage is supplied to a driving ribbon group corresponding to the standing ribbons.

4. The optical modulator of claim 3, wherein a voltage is supplied to a driving ribbon group corresponding to the driving ribbons such that a driving ribbon group corresponding to the standing ribbons can have a relative displacement corresponding to a luminance of a pixel to be rendered in the image frame.

5. The optical modulator of claim 2, wherein a voltage is supplied to a driving ribbon group corresponding to the standing ribbons.

6. The optical modulator of claim 5, wherein a voltage is supplied to a driving ribbon group corresponding to the driving ribbons such that a driving ribbon group corresponding to the standing ribbons can have a relative displacement corresponding to a luminance of a pixel to be rendered in the image frame.

7. The optical modulator of claim 2, wherein a voltage supplied in a preceding image frame is continuously supplied to a driving ribbon group corresponding to the standing ribbons.

8. The optical modulator of claim 7, wherein a voltage is supplied to a driving ribbon group corresponding to the driving ribbons such that a driving ribbon group corresponding to the standing ribbons can have a relative displacement corresponding to a luminance of a pixel to be rendered in the image frame.

9. The optical modulator of claim 1, wherein initial locations of ribbons are corrected with reference to a ribbon, the bottom of which is the lowest among ribbons belonging to the first driving ribbon group and the second driving ribbon group.

10. The optical modulator of claim 1, wherein initial locations of ribbons are corrected with reference to a ribbon, the bottom of which is the highest among ribbons belonging to the first driving ribbon group and the second driving ribbon group.
